(19) United States
(12) Patent Application Publication
(10) Pub. No.: US 2008/0068266 A1
(43) Pub. Date: Mar. 20, 2008

(54) Beamforming for spatial sidelobe cancellation and AMR direction finding

(75) Inventor: William C. DeAgro, Shirley, NY (US)

Correspondence Address: PIETRAGALLO GORDON ALFANO BOSICK & RASPANTI, LLP, ONE OXFORD CENTRE, 38TH FLOOR, 301 GRANT STREET, PITTSBURGH, PA, 15219-6404, US

(73) Assignee: Northrop Grumman Corporation, Los Angeles, CA (US)

(21) Appl. No.: 11/287,544

(22) Filed: Nov. 23, 2005

(51) Int. Cl. G01S 5/02

(52) U.S. Cl. 342/424

(57) ABSTRACT

An apparatus comprising an array of antenna elements, a beamformer for adjusting signals to and from the elements to form a first beam pattern and a second beam pattern, and wherein the first beam pattern is a sum pattern and the second beam pattern is a null pattern. A method of beamforming for sidelobe cancellation is also provided.

### FIELD OF THE INVENTION

This invention relates to antenna systems, and more particularly to such systems that include spatial sidelobe cancellation.

### BACKGROUND OF THE INVENTION

In monopulse radar systems, Identification; Friend or Foe (IFF) systems, as well as in many other systems, the antenna is an array of individual elements whose elemental signals are combined to form two main signal channels. One of these channels (commonly called the Sum channel) includes a narrow main beam directed along a pointing angle, or boresight, and having high directivity and a plurality of inherent undesired residual sidelobes which are off boresite. The Sum channel is generated by summing all of the antenna elements. Many times prior to any summing and/or signal combining, the individual antenna array elemental signals are pre-scaled (or Weighted) to achieve application specific optimization of such parameters as beamwidth, and main beam gain as well as limited control of sidelobes. Irregardless of whether Weighting has been incorporated, the main beam of the Sum channel is the desired portion, however because of the inherent undesired residual sidelobes, undesired energy will be transmitted and received at azimuth angles other than the pointing angle (assuming a horizontally aligned array, and correspondingly at elevation angles for a vertically aligned array). As a result undesired incoming signals and returns can result from reflected energy, jammers or other sources not in the direction of interest. This unwanted energy can corrupt systems such as radar and Identification; Friend or Foe (IFF), etc.

To reduce the effects of the undesired Sum channel sidelobes, a common method employs a second auxiliary channel, called a Difference channel. The classic Difference channel is used to provide a second signal which can be compared to the Sum signal channel to determine if received signal energy is at boresite and valid or not. The Difference channel has a characteristic response such that its gain in the direction of the Sum channel pointing angle is lower than the Sum channel, but the Difference channel gain in other directions is intended to be higher than the gain of the Sum channel sidelobes. When signals are received, an amplitude comparison is made between the Sum and Difference channel outputs to distinguish (and eliminate) undesired signals that arrive at the undesired angles. This is sometimes referred to as sidelobe cancellation.

A classic type Difference channel is not only used to provide sidelobe cancellation of the unwanted signals but sometimes to allow for Amplitude Monopulse Ratio (AMR) direction finding. When received energy is in a predetermined boresite angular sector, a comparison of the two channels can be used to find the angular direction of the incoming signal. This is due to the Difference channel characteristics that include a sharp null, which occurs in the same angular sector as the Sum channel main beam points, and the amplitude ratio value of these two channels thus varies with angle.

The Difference channel also contains spatial sidelobes. In order to properly discern good signals from undesired ones so that sidelobe cancellation of undesired signals results, the sidelobes of the Difference channel should be higher than the Sum channel sidelobes. This is generally quite difficult to achieve since Difference channel sidelobes frequently tend to dip down below the Sum channels sidelobe levels resulting in what is known as punch through.

It would be desirable to provide methods and apparatus that include spatial sidelobe cancellation while avoiding the deficiencies of the classic Difference channel approach.

### SUMMARY OF THE INVENTION

This invention provides an apparatus comprising an array of antenna elements, a beamformer for adjusting signals to and from the elements to form a first beam pattern and a second beam pattern, and wherein the first beam pattern is a sum pattern and the second beam pattern is a null pattern.

In another aspect the invention provides a method of beamforming for sidelobe cancellation, the method comprising the steps of producing a sum channel having a main beam oriented along a boresight, and a plurality of sidelobes, and producing a null channel having a null oriented along the boresight. The null channel includes an omni-like pattern overlapping the plurality of sidelobes and having a greater gain than the sidelobes, to provide a greater margin and eliminate a punch through condition.

The invention further encompasses a method of direction finding comprising the steps of: producing a sum channel having a main beam oriented along.a boresight, and a plurality of sidelobes; producing a null channel having a null oriented along the boresight, and an omni-like pattern overlapping the plurality of sidelobes; and comparing the sum channel to the null channel to determine an Amplitude Monopulse Ratio.

### BRIEF DESCRIPTION OF THE DRAWINGS

FIG. 1 is a block diagram of an antenna system constructed in accordance with the invention.

FIGS. 2, 3, 4, and 5 are plots of beamformed antenna patterns.

### DETAILED DESCRIPTION OF THE INVENTION

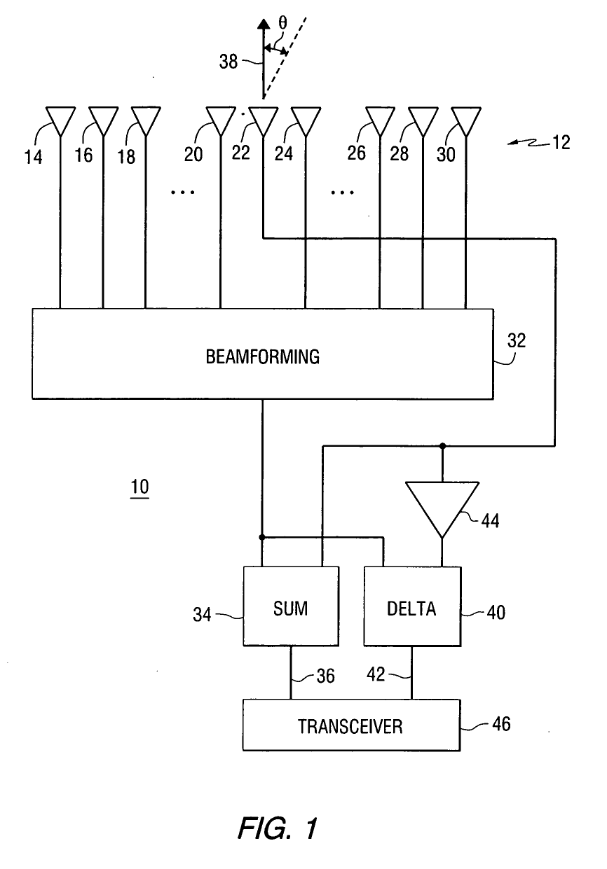

Referring to the drawings, FIG. 1 is a block diagram of an antenna system 10 in accordance with the invention. The system includes an antenna array 12 having a plurality of individual antenna elements 14, 16, 18, 20, 22, 24, 26, 28 and 30. In this example, the individual antenna elements are arranged in a linear array and are evenly spaced with respect to each other. Those skilled in the art will realize that the antenna array doesn't necessarily need to be a linear one, but in general and for most cases it should be symmetric about the center. A Beamforming block 32 is used to control the signals that are transmitted from or received by the antenna elements.

During the receive mode, Beamforming block 32 may be a simple summation of the antenna element signals (or may take the form of a weighted summation for a more application specific need). Subsequent to this beamforming, signals are then combined in Sum block, also referred to as a sum element, 34 (via an addition) to produce the final Sum channel signal output on line 36 resulting in a main beam positioned in the boresight direction indicated by line 38. The system includes a Delta block, also referred to as a difference element 40, which combines the antenna element signals (via subtraction) into the final Null channel signal on line 42 having a null positioned in a boresight direction. A level compensator 44 is connected between the center element 22 and Delta block 40. The purpose of the level compensator is to optimize nulling. For embodiments using a level compensator 44 having unity gain as an RF hardware type implementation choice, a single hardware component called a Sum/Difference Hybrid may be used to take the place of all three blocks 34, 40 and 44 thus reducing the amount of hardware required. Lastly, Transceiver 46 receives and processes signals from both Sum block 34 and Delta block 40.

During transmit, the transceiver supplies a signal up to Sum block 34 via line 36. Sum block 34 will then split this signal equally into two output signals that exit out the top of Sum block 34. One of these output signals feeds antenna element 22 directly. Beamformer 32 takes in the other Sum block 34 output signal at its bottom and internally splits it equally amongst the antenna elements it connects to at the top. For application specific optimization, Beamformer 32 may also weight (i.e., scale) each of the signals prior to its final application to the individual antenna elements. The Delta block 40 and Level Compensator 44 are not needed during transmit.

For the purposes of this description, signals are mainly described as if the system is in a receive mode. However, those skilled in the art will recognize that the transmit mode forms similar antenna patterns.

Spatial sidelobe cancellation techniques are used to reduce or eliminate the effects of unwanted received energy from directions other than boresite for a variety of system types. Such energy is a result of external emitters as well as an undesired signal that is transmitted and reflected back from directions other than the boresite. Spatial sidelobe cancellation is normally achieved by using two beam patterns. A main (Sum) channel is directional and has lower gain at the undesired azimuths. Another auxiliary channel (normally a Difference type) has a center main beam null and is designed with attempts for its sidelobe structure to always be higher than that of the Sum channel. For the best case, the auxiliary channel would be desired to be omni-like off boresite which a classic Difference channel cannot achieve.

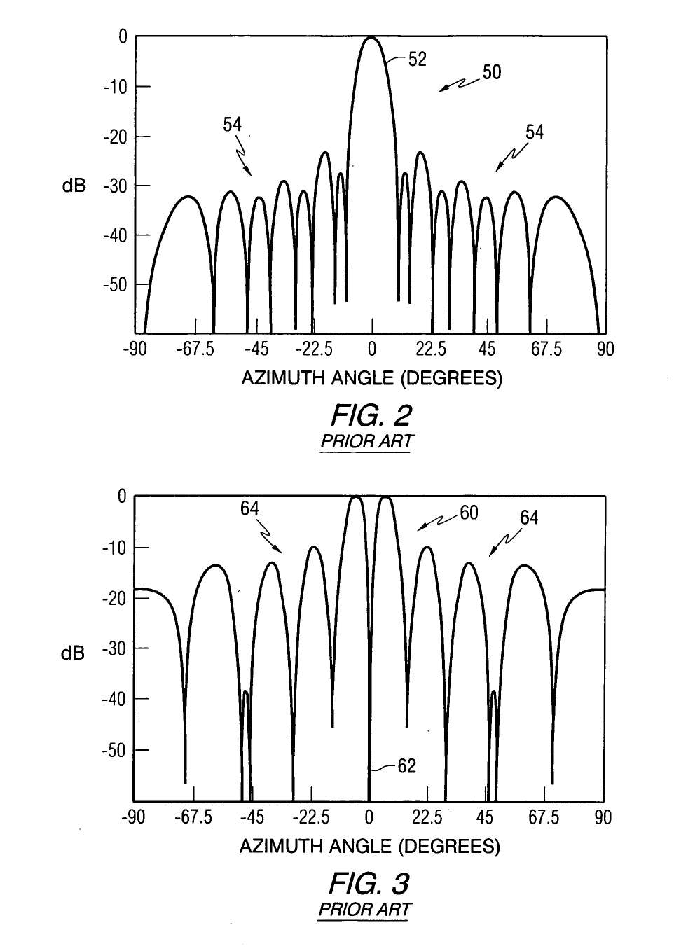

FIG. 2 is a plot of an antenna Sum pattern 50 of a prior art antenna. The Sum pattern includes a main lobe 52 and a plurality of sidelobes 54. FIG. 3 is a plot of an antenna Difference pattern 60 of a prior art antenna. The Difference pattern includes a null 62 at the boresight and a plurality of sidelobes 64. FIG. 3 depicts a typical classic Difference pattern whose sidelobes periodically dips down at or near sidelobe null points and will cause punch through.

Systems constructed and operated in accordance with this invention do not contain the classic Difference auxiliary type channel but rather include an omni-like Null (or notched) auxiliary type channel. This Null channel can be configured to have a very good omni-like pattern that extends over a wide angle such as +90 degrees azimuth (in lieu of having the sidelobe content and associated multiple sidelobe nulls that a classic Difference type channel exhibits). The Null channel also resembles a spatial notch filter with the notch at an angle which corresponds to the Sum channel main beam center. The Null channel provides the needed additional margin against punch through while it's notch, which is not quite exactly the same as that of the Difference channel null, allows for some Amplitude Monopulse Ratio (AMR) Direction Finding capability.

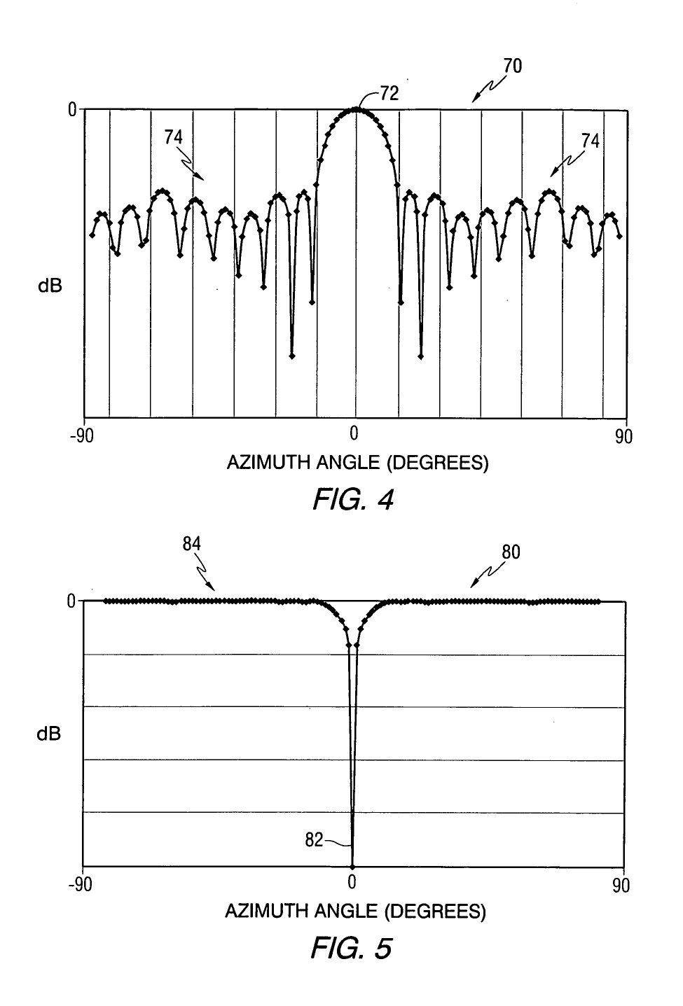

FIG. 4 is a plot of an antenna Sum pattern 70 constructed in accordance with this invention. The Sum pattern includes a main lobe 72 and a plurality of sidelobes 74. FIG. 5 is a plot of an antenna Null pattern 80 constructed in accordance with this invention. The Null pattern includes a null 82 at the boresight and an omni-like pattern 84 off boresight. FIGS. 2 and 4 are example Sum channel patterns each depicting similar sidelobe levels. FIG. 5 depicts the proposed Null channel pattern of this invention, which inherently does not have the same periodic dipping sidelobe structure, thus overcoming the punch through problem.

Two basic methods to accomplish more omni-like auxiliary beam patterns will be described. The first method produces a pattern that is better in shape than a classic Difference channel but not quite as good in terms of omni-like performance as the second method described which is a true Null type channel.

In the first method a Modified Difference channel is created by using fewer antenna array elements (than that used by the Sum channel). This is accomplished by symmetrically not using elements from each of the outer ends of the array and using only the centrally located elements to form the Modified Difference channel. As the number of outer end elements is reduced, the Difference channel pattern will spread out and form a pattern shape less crude than the classic Difference channel in terms of it's sidelobe structure. This spreading will result in fewer undesired sidelobes and fewer associated sidelobe nulls and less chances for punch through, however it will exhibit lower gain than the typical Difference channel and attain a much wider, far less sharp null characteristic, which is less desirable. When this Modified Difference channel uses as few as only the two center elements, no sidelobe nulls may exist, but at the same time the null will broaden very significantly which is not so desired.

The second method requires forming a true omni type notched Null channel which is characteristically opposite that of the Sum channel main beam pattern and is described as follows. First the Sum channel main beam pattern can be expressed or approximated as a spatial weighting function of:

w(x)=ƒ(x)*Σ{(x−mX)}

where w(x) is the weighted sum of all of the elements (representing the Sum channel output 36 transfer function), ƒ(x) is a user defined weighting function, δ is the impulse function representing a single antenna element of the array, X is the element spacing and m is the summation index (allowing as many summations as required in order to combine all the antenna elements that exist in the array). The index m is also symmetrical and centered about 0 and attains the value of 0 when the center array element is added in.

The Sum antenna pattern characteristic versus sin(O) is the Fourier Transform of w(x), where 0 is the azimuth angle for a horizontally aligned array (and the elevation angle for a vertically aligned array).

By using an odd number of elements in the array and knowing that δ(x) has a Fourier Transform which is a constant, a more complete omni-like Null channel n(x) is formed as follows:

n(x)=k*,5(x)−w(x)

where k is a constant, chosen based on fix), such that null depth is optimized (via the level compensator 44). Since 6(x) only relates to the center element, n(x) is formed exactly the same as w(x) with the exception of the way the center element is combined into it. With this, all elements except the center element can be combined or summed by Beamformer 32 as in FIG. 1. The final Sum channel would then simply add in the middle element via Sum block 34 to result in the signal on line 36, and the Null channel would be formed via a subtraction with the middle element path by Delta block 40 to achieve the omni-like Null channel signal on line 42.

For an antenna array consisting of an even number of elements, a very similar approach can be taken. For the even element array, no middle element exists and an equivalent center element must first be synthesized. This is done by first pre-adding two (or more) symmetrically centrally located antenna elements into a single output. This subconfiguration output would then take the place of the center antenna element 22 of FIG. 1, and the rest of FIG. 1 is the same for the remaining elements. It should noted that pre-adding symmetrically centrally located antenna elements, as described above, is not limited to a symmetrical even element array and can also be done with an odd element antenna array if so desired. The benefit of combining central elements in either case is increased channel gain.

This invention uses a Null auxiliary channel which is omni-like instead of a classic Difference auxiliary channel. The Null auxiliary channel is not only easy to create but it doesn't have the problematic varying sidelobes and associated sidelobe nulls the classic Difference channel exhibits, as its characteristic is omni-like for directions other than boresite.

The signal levels of the two channels can be compared. If the Sum channel is greater than the auxiliary channel, then the signal is an at boresite, valid signal. If the auxiliary channel is greater than the sum channel, then the signal is an off boresite, invalid signal, that can be ignored.

While the invention has been described in terms of several embodiments, it will be apparent to those skilled in the art that various changes can be made to the described embodiments without departing from the scope of the invention as set forth in the following claims.

1. An apparatus comprising:
an array of antenna elements including a center element and a plurality of other elements symmetrically positioned with respect to the center element;
a beamformer for adjusting signals to and from the plurality of other elements to form a first beam pattern;
a sum element for adding signals from the beamformer and the center element to form a sum pattern; and
a difference element for subtracting signals from the beamformer and the center element to form a null pattern including a null aligned with a boresight of the array of antenna elements, and an omni-like pattern on opposite sides of the boresight.

2. (canceled)

3. (Canceled)

4. (Canceled)

5. (Canceled)

6. The apparatus of claim 1, further comprising:
a level compensator for adjusting a level of the signal from the center element.

7. The apparatus of claim 1, further comprising:
a transceiver for receiving signals from, and for transmitting signals to, the sum element and the difference element.

8. The apparatus of claim 7, wherein:
during transmission, the sum element splits a transmission signal between the beamformer and the center element.

9. The apparatus of claim 8, wherein:
the beamformer splits and scales the transmission signal.

10. (canceled)

11. A method of beamforming for sidelobe cancellation, the method comprising:
providing an array of antenna elements including a center element and a plurality of other elements symmetrically positioned with respect to the center element;
using a beamformer to adjust signals to and from the plurality of other elements to form a first beam pattern:
adding signals from the beamformer and the center element to form a sum pattern: and subtracting signals from the beamformer and the center element to form a null pattern including a null aligned with a boresight of the array of antenna elements, and an orrni-like pattern on opposite sides of the boresight.

12. (canceled)

13. (canceled)

14. (canceled)

15. The method of claim 11, further comprising
adjusting a level of the signal from the center element.

16. (canceled)

17. The method of claim 11, comprising:
splitting a transmission signal between the plurality of other elements and the center element.

18. (canceled)

19. (canceled)

20. (canceled)
